(19) United States
(12) Patent Application Publication
(10) Pub. No.: US 2011/0264443 A1
(43) Pub. Date: Oct. 27, 2011

(54) INFORMATION PROCESSING DEVICE, INFORMATION PROCESSING METHOD, AND PROGRAM

(76) Inventor: SHINGO TAKAMATSU, TOKYO (JP)

(21) Appl. No.: 13/084,756

(22) Filed: Apr. 12, 2011

(30) Foreign Application Priority Data
Apr. 21, 2010 (JP) P2010-097917

(51) Int. Cl. G06F 17/27

(52) U.S. Cl. 704/9; 704/E11.001

(57) ABSTRACT

Disclosed herein is an information processing device including: a data acquirer configured to acquire a sentence collection having a plurality of sentences and a plurality of phrases included in the sentence collection; a phrase feature decider configured to decide phrase features each representing a characteristic of a respective one of the phrases acquired by the data acquirer; a collection feature decider configured to decide a collection feature representing a characteristic of the sentence collection; and a compressor configured to generate compressed phrase features by using the phrase features and the collection feature, the compressed phrase features having a dimension lower than a dimension of the phrase features and each representing a characteristic of the respective one of the phrases acquired by the data acquirer.

### BACKGROUND OF THE INVENTION

1. Field of the Invention

The present invention relates to an information processing device, an information processing method, and a program.

2. Description of the Related Art

In recent years, against the backdrop of enhancement in the information processing ability of computers, a technique to statistically treat the semantic aspect of texts is attracting attention in the field of natural language processing. One example of this technique is a document classification technique to analyze the contents of documents and classify the respective documents into various genres. Another example is a text mining technique to extract beneficial information from a collection of accumulated texts such as Web pages on the internet or a history of questions and opinions sent from customers in a company.

In general, even in the case of expressing one same or similar meaning, different words or phrases are often used in the text. So, it is attempted in statistical analysis of texts to distinguish texts having a similar meaning by defining a vector space for representing the statistical characteristics of the texts and clustering the features of the respective texts in the vector space (e.g. refer to Alexander Yates and Oren Etzioni, “Unsupervised Methods for Determining Object and Relation Synonyms on the Web,” Journal of Artificial Intelligence Research (JAIR) 34, March, 2009, pp. 255-296 (hereinafter, non-patent document 1)). As the vector space for representing the statistical characteristics of the texts, e.g. a vector space made by disposing the individual words included in vocabulary likely to appear in the texts as the individual components of the vector (axes of the vector space) is frequently used.

### SUMMARY OF THE INVENTION

However, although the technique of clustering features is effective in at least e.g. classification of documents having plural sentences, it is difficult for the technique to produce a significant result in the case of attempting to recognize an equivalence or synonymous relationship of phrases. The main reason for this is that the number of words included in a phrase is small. For example, a document such as a news article or a Web page introducing a person, contents, or a product generally includes several tens to several hundreds of words. In contrast, the phrase, which is the unit smaller than one sentence, generally includes only several words. Therefore, because even the feature of a document tends to be obtained as a sparse vector (vector in which most part of components is zero), the feature of a phrase will be obtained as a super-sparse vector, which is a much sparser vector. Such a super-sparse vector has an aspect that information usable as a clue in recognition of the meaning is little. This results in e.g. the following problem. Specifically, in clustering based on the similarity (e.g. cosine distance) between super-sparse vectors, two or more vectors that should belong to one cluster in terms of the meaning are not clustered into one cluster.

For example, there also exists a technique to compress a higher-dimensional vector to a lower-dimensional vector by using a probabilistic technique such as singular value decomposition (SVD), probabilistic latent semantic analysis (PLSA) relating to latent meaning analysis, or latent dirichlet allocation (LDA). These probabilistic techniques effectively function in compression of the dimension of the feature of a document. However, if these probabilistic techniques are simply applied to the feature of a phrase as a super-sparse vector, the significance of data is lost and only output that is not suitable for subsequent-stage processing such as clustering is obtained in many cases. The above-described non-patent document 1 proposes to, for such a situation, ensure a large-scale data collection by collecting strings the number of which is on the order of several millions from texts on the Web for the purpose of achieving the significance of the feature about a short string. However, treating such a large-scale data collection causes a problem of restrictions on the resource. Furthermore, there are also many cases in which a large-scale data collection can not be ensured essentially, such as the case of treating a subject that belongs to the so-called long tail.

There is a need for the present invention to provide novel, improved information processing device, information processing method, and program capable of compressing the dimension of the features of phrases with maintenance or enhancement of the significance of the features in order to facilitate recognition of an equivalence or synonymous relationship at the phrase level for example.

According to a mode of the present invention, there is provided an information processing device including a data acquirer configured to acquire a sentence collection having a plurality of sentences and a plurality of phrases included in the sentence collection, and a phrase feature decider configured to decide phrase features each representing a characteristic of a respective one of the phrases acquired by the data acquirer. Furthermore, the information processing device also includes a collection feature decider configured to decide a collection feature representing a characteristic of the sentence collection, and a compressor configured to generate compressed phrase features by using the phrase features and the collection feature. The compressed phrase features have a dimension lower than the dimension of the phrase features and each represent a characteristic of the respective one of the phrases acquired by the data acquirer.

According to this configuration, the information processing device compresses the phrase feature with compensation for little information of the feature by using the collection feature representing the characteristic of the sentence collection as the acquisition source of phrases in addition to the phrase features representing the characteristics of the respective phrases.

The phrase feature may be vector quantity having components each corresponding to a respective one of words that appear in the plurality of phrases.

The collection feature may be a matrix having components each corresponding to a respective one of combinations of words that appear in the sentence collection, and at least part of a vector space of the phrase feature may overlap with part of a vector space of row vectors or column vectors configuring the collection feature.

The compressor may calculate a latent variate by maximum likelihood estimation in a probabilistic model in which the phrase features about the plurality of phrases and the collection feature are treated as observed data and the latent variate contributes to the occurrence of the observed data, and the compressed phrase feature may be included in the latent variate.

A latent variate that contributes to the occurrence of the collection feature and a latent variate that contributes to the occurrence of the phrase feature may be latent variates that are in common with each other at least partially in the probabilistic model.

The compressor may calculate a first lower-order matrix having an order lower than the order of the collection feature by matrix decomposition of the collection feature, and calculate a second lower-order matrix having an order lower than the order of a phrase feature matrix including the phrase features about the plurality of phrases by matrix decomposition of the phrase feature matrix. Furthermore, the second lower-order matrix may be a matrix that approximately derives the phrase feature matrix by a product with a matrix having part in common with the first lower-order matrix, and the compressed phrase feature may be included in the second lower-order matrix. The first lower-order matrix and the second lower-order matrix can be equivalent to e.g. a lower-order matrix Mt4 and a lower-order matrix Mt1, respectively, which will be described later.

The collection feature decider may decide the collection feature depending on the number of times of co-occurrence in the sentence collection about each of the combinations of the words.

The collection feature decider may decide the collection feature depending on a synonymous relationship between words.

The information processing device may further include a clustering part configured to perform clustering of a plurality of compressed phrase features generated by the compressor depending on similarity between features.

The clustering part may give each of at least one clusters generated as a result of clustering a label corresponding to a phrase as a representative of the cluster.

The data acquirer may extract pairs of words that are both included in one sentence in the sentence collection and acquire the plurality of phrases each representing a relation between the words about a respective one of the extracted pairs.

The information processing device may further include a clustering part configured to perform clustering of a plurality of compressed phrase features generated by the compressor depending on similarity between features, and a summarizer configured to pay attention to a specific word included in the sentence collection and create summary information about an attention word by using a result of clustering by the clustering part about phrases relating to the attention word.

According to another mode of the present invention, there is provided an information processing method carried out by using processing means in an information processing device. The information processing method includes the steps of acquiring a sentence collection having a plurality of sentences and a plurality of phrases included in the sentence collection, and deciding phrase features each representing a characteristic of a respective one of the acquired phrases. Furthermore, the information processing method also includes the steps of deciding a collection feature representing a characteristic of the acquired sentence collection, and generating compressed phrase features by using the phrase features and the collection feature. The compressed phrase features have a dimension lower than the dimension of the phrase features and each represent a characteristic of a respective one of phrases among the plurality of phrases.

According to another mode of the present invention, there is provided a program for causing a computer that controls an information processing device to function as processing means including a data acquirer configured to acquire a sentence collection having a plurality of sentences and a plurality of phrases included in the sentence collection, and a phrase feature decider configured to decide phrase features each representing a characteristic of a respective one of the phrases acquired by the data acquirer. Furthermore, the unit also includes a collection feature decider configured to decide a collection feature representing a characteristic of the sentence collection, and a compressor configured to generate compressed phrase features by using the phrase features and the collection feature. The compressed phrase features have a dimension lower than the dimension of the phrase features and each represent a characteristic of the respective one of the phrases acquired by the data acquirer.

As described above, the information processing device, the information processing method, and the program according to the modes of the present invention can compress the dimension of the features of phrases with maintenance or enhancement of the significance of the features.

### BRIEF DESCRIPTION OF THE DRAWINGS

FIG. 1 is a block diagram showing one example of the configuration of an information processing device according to one embodiment of the present invention;

FIG. 2 is a first explanatory diagram for explaining acquisition of phrases by a data acquirer according to the embodiment;

FIG. 3 is a second explanatory diagram for explaining the acquisition of phrases by the data acquirer according to the embodiment;

FIG. 4 is a flowchart showing one example of the flow of data acquisition processing according to the embodiment;

FIG. 5 is an explanatory diagram for explaining decision of phrase features by a phrase feature decider according to the embodiment;

FIG. 6 is a flowchart showing one example of the flow of phrase feature decision processing according to the embodiment;

FIG. 7 is an explanatory diagram for explaining decision of a collection feature by a collection feature decider according to the embodiment;

FIG. 8A is a flowchart showing a first example of the flow of collection feature decision processing according to the embodiment;

FIG. 8B is a flowchart showing a second example of the flow of the collection feature decision processing according to the embodiment;

FIG. 9A is a first explanatory diagram for conceptually explaining compression of phrase features according to the embodiment;

FIG. 9B is a second explanatory diagram for conceptually explaining the compression of phrase features according to the embodiment;

FIG. 10 is an explanatory diagram for explaining one example of the result of clustering of phrases by a clustering part according to the embodiment;

FIG. 11 is a flowchart showing one example of the flow of clustering processing according to the embodiment;

FIG. 12 is an explanatory diagram for explaining one example of summary information created by a summarizer according to the embodiment;

FIG. 13 is a flowchart showing one example of the flow of summary information creation processing according to the embodiment; and

FIG. 14 is a flowchart showing one example of the overall flow of information processing according to the embodiment.

### DETAILED DESCRIPTION OF THE PREFERRED EMBODIMENT

A preferred embodiment of the present invention will be described in detail below with reference to the accompanying drawings. In the present specification and the drawings, the constituent element having substantially the same functional configuration is given the same numeral, to thereby omit overlapping description.

This “DETAILED DESCRIPTION OF THE PREFERRED EMBODIMENT” will be described in the following order.

### 1. Overall Configuration Example of Information Processing Device According to One Embodiment

### 2. Description of Respective Parts

2-1. Document DB

2-2. Data Acquirer

2-3. Phrase Feature Decider

2-4. Collection Feature Decider

2-5. Feature DB

2-6. Compressor

2-7. Compressed Feature DB

2-8. Clustering Part

2-9. Summarizer

2-10. Summary DB

### 3. Flow of Information Processing

### 4. Application Examples

### 5. Summary

### 1. Overall Configuration Example of Information Processing Device According to One Embodiment

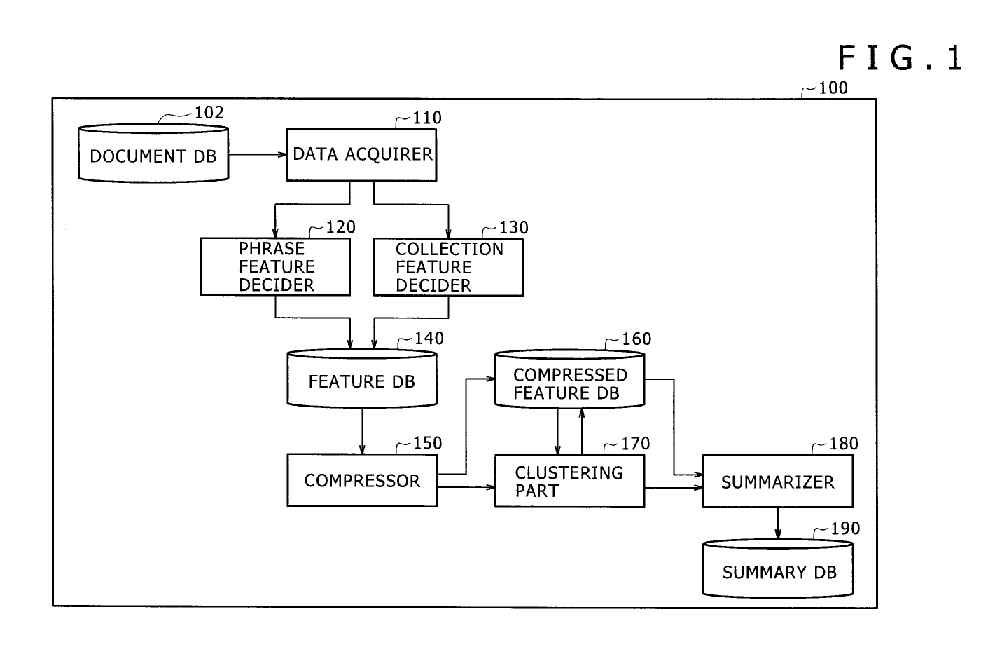

FIG. 1 is a block diagram showing one example of the configuration of an information processing device 100 according to one embodiment of the present invention. Referring to FIG. 1, the information processing device 100 includes a document database (DB) 102, a data acquirer 110, a phrase feature decider 120, a collection feature decider 130, a feature DB 140, a compressor 150, a compressed feature DB 160, a clustering part 170, a summarizer 180, and a summary DB 190. The information processing device 100 may be a device of an arbitrary kind, such as a high-performance computer, a personal computer (PC), a smart phone, a digital home appliance, a game machine, or an AV player. Of the constituent elements of the information processing device 100, the document DB 102, the feature DB 140, the compressed feature DB 160, and the summary DB 190 are typically configured by using a storage medium such as a hard disc or a semiconductor memory. The storage medium may exist inside the information processing device 100 or outside the information processing device 100.

### 2. Description of Respective Parts

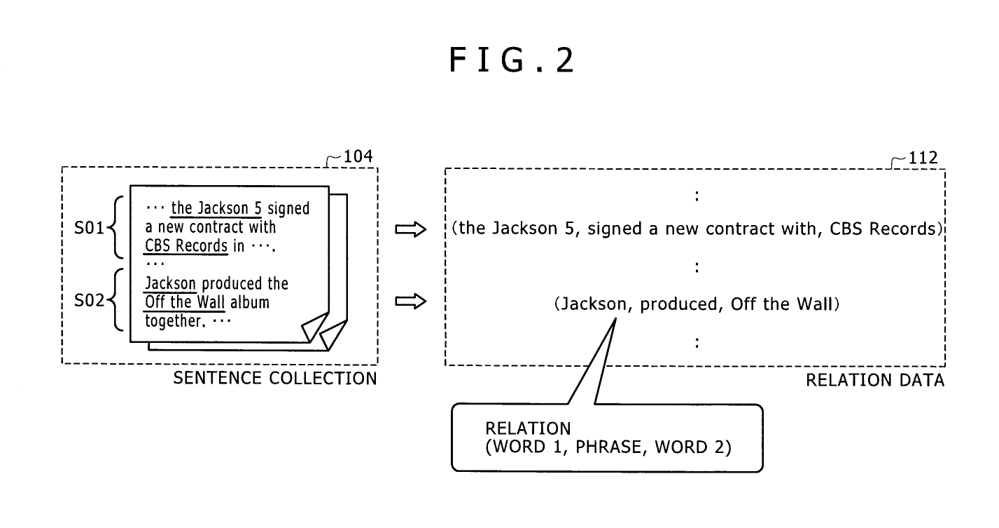

The respective constituent elements of the information processing device 100 shown in FIG. 1 will be described below with use of FIG. 2 to FIG. 13.

### [2-1. Document DB]

The document DB 102 is a database storing a sentence collection having plural sentences in advance. The sentence collection stored by the document DB 102 may be a collection of documents such as news articles, electronic dictionaries, or Web pages introducing persons, contents, or products. Alternatively, the sentence collection stored by the document DB 102 may be e.g. e-mails, written sentences on electronic bulletin boards, or a history of some kind of texts input in a form on the Web. Further alternatively, the sentence collection stored by the document DB 102 may be e.g. a corpus made by turning speech by a person into texts. The document DB 102 outputs the stored sentence collection to the data acquirer 110 in response to a request from the data acquirer 110.

### [2-2. Data Acquirer]

The data acquirer 110 acquires a sentence collection having plural sentences from the document DB 102. Furthermore, the data acquirer 110 acquires plural phrases included in the sentence collection. Specifically, the data acquirer 110 extracts pairs of words that are both included in one sentence in the sentence collection and acquires plural phrases each representing the relation between the words about a respective one of the extracted pairs. The word pair extracted from the sentence collection by the data acquirer 110 may be an arbitrary word pair. In the scheme of the present embodiment, as one example, the data acquirer 110 extracts a pair of proper nouns particularly and acquires a phrase representing the relation between the proper nouns.

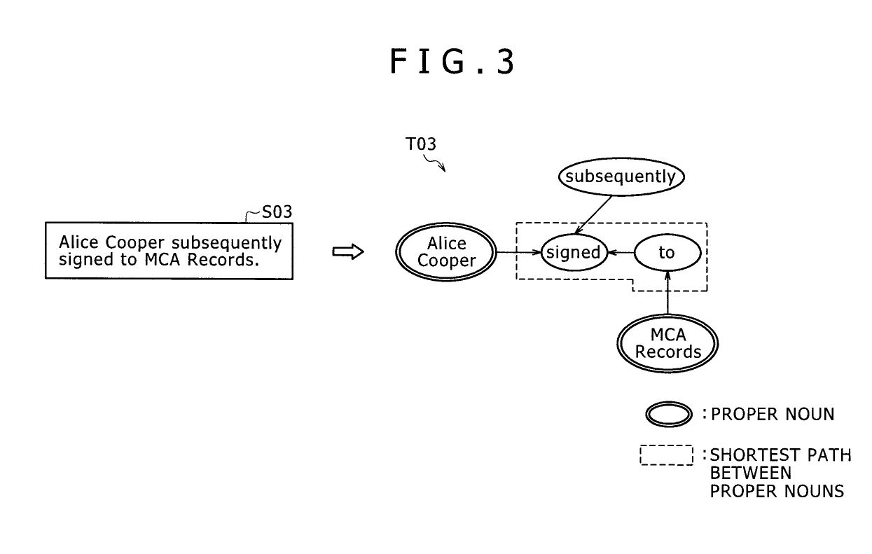

FIG. 2 and FIG. 3 are explanatory diagrams for explaining acquisition of phrases from a sentence collection by the data acquirer 110.

Referring to FIG. 2, a sentence collection 104 as one example acquired from the document DB 102 is shown. The sentence collection 104 has e.g. a first sentence S01 and a second sentence S02. The data acquirer 110 first recognizes such individual sentences included in the sentence collection 104 and specifies sentences in each of which two or more proper nouns appear among the recognized sentences. The discrimination of the proper nouns can be carried out by using e.g. a publicly-known named entity extraction technique. For example, the first sentence S01 in FIG. 2 includes two proper nouns, “Jackson 5” and “CBS Records.” The second sentence S02 includes two proper nouns, “Jackson” and “Off the Wall.” Next, the data acquirer 110 performs syntax analysis about each of the specified sentences and derives syntax trees. Subsequently, the data acquirer 110 acquires phrases each linking the pair of two proper nouns in the derived syntax trees. In the example of FIG. 2, the phrase linking “Jackson 5” and “CBS Records” in the first sentence S01 is “signed a new contract with.” The phrase linking “Jackson” and “Off the Wall” in the second sentence S02 is “produced.” In the present specification, the set of such one pair of words and the phrase corresponding to this one pair is referred to as the relation.

FIG. 3 shows one example of the syntax tree derived by the data acquirer 110. In the example of FIG. 3, the data acquirer 110 analyzes the syntax of a third sentence S03 to thereby derive a syntax tree T03. The syntax tree T03 has the shortest path, “signed to,” between two proper nouns, “Alice Cooper” and “MCA Records.” The adverb, “subsequently,” is out of the shortest path between two proper nouns. The data acquirer 110 may extract a word pair satisfying a predetermined extraction condition based on the result of such syntax analysis and may acquire a phrase about only this extracted pair. The predetermined extraction condition may be e.g. the following conditions E1 to E3.

condition E1: a node equivalent to a sentence delimiter does not exist on the shortest path between proper nouns.

condition E2: the length of the shortest path between proper nouns is equal to or shorter than three nodes.

condition E3: the number of words between proper nouns in the sentence collection is equal to or smaller than 10.

The sentence delimiter in condition E1 is e.g. a relative pronoun and a comma. These extraction conditions prevent the data acquirer 110 from erroneously acquiring a string that is not suitable as the phrase representing the relation between two proper nouns.

The phrase extraction from the sentence collection may be carried out in advance in an external device outside the information processing device 100. In this case, the data acquirer 110 acquires the phrases extracted in advance and the sentence collection as the extraction source from the external device at the start of information processing by the information processing device 100.

The data acquirer 110 outputs relation data 112 including the plural phrases acquired in this manner to the phrase feature decider 120. Furthermore, the data acquirer 110 outputs the sentence collection used as the basis of the phrase acquisition to the collection feature decider 130.

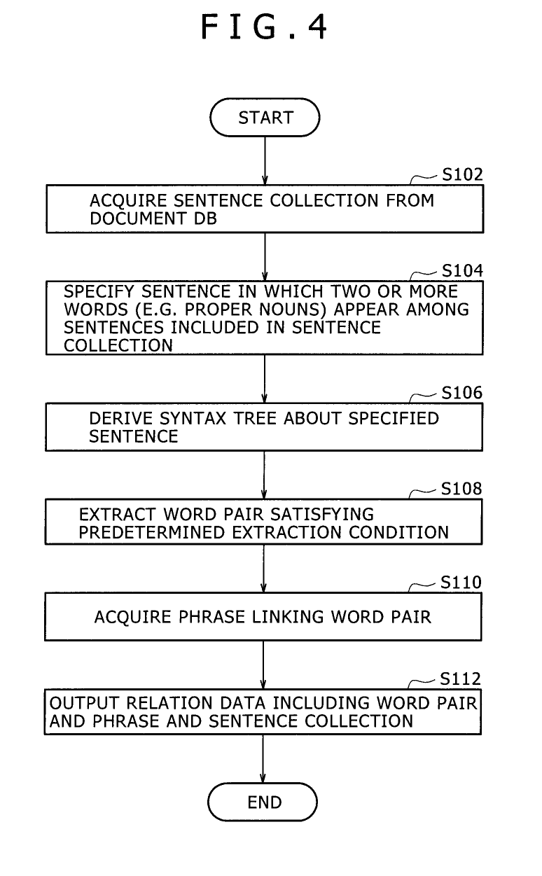

FIG. 4 is a flowchart showing one example of the flow of the data acquisition processing performed by the data acquirer 110 according to the present embodiment.

Referring to FIG. 4, first, the data acquirer 110 acquires a sentence collection from the document DB 102 (step S102). Next, the data acquirer 110 specifies sentences in which two or more words (e.g. proper nouns) appear among the sentences included in the acquired sentence collection (step S104). Next, the data acquirer 110 derives the syntax trees of the respective sentences by analyzing the syntax of the specified sentences (step S106). Next, the data acquirer 110 extracts word pairs satisfying the predetermined extraction condition (e.g. the above-described conditions E1 to E3) from the sentences specified in the step S104 (step S108). Next, the data acquirer 110 acquires the phrase linking the extracted word pair from each corresponding one of the sentences (step S110). Subsequently, the data acquirer 110 outputs, to the phrase feature decider 120, the relation data 112 including plural relations each equivalent to the set of the word pair and the corresponding phrase. Furthermore, the data acquirer 110 outputs the sentence collection used as the basis of the phrase acquisition to the collection feature decider 130 (step S112).

### [2-3. Phrase Feature Decider]

The phrase feature decider 120 decides the phrase features representing the characteristics of the respective phrases acquired by the data acquirer 110. In the present embodiment, the phrase feature is vector quantity in a vector space having components each corresponding to a respective one of the words that appear in plural phrases one or more times. Specifically, for example if 300 kinds of words appear in 100 phrases, the dimension of the phrase feature can be 300 dimensions. The phrase feature decider 120 decides the vector space of the phrase feature based on the vocabulary of the words that appear in the plural phrases, and then decides the phrase feature of each phrase depending on the presence or absence of the appearance of each word in the phrase. For example, in the phrase feature of each phrase, the phrase feature decider 120 may set “1” as the component corresponding to a word that appears in the phrase and set “0” as the component corresponding to a word that does not appear.

In the decision of the vector space of the phrase feature, it is preferable that words making little sense in representation of the characteristic of a phrase (e.g. articles, demonstrative words, and relative pronouns) be regarded as stop words and the words equivalent to the stop words be excluded from the components. Furthermore, for example, the phrase feature decider 120 may evaluate the TF/IDF (term frequency/inverse document frequency) score of the words that appear in the phrases and may exclude words having a low score (i.e. having low importance) from the components of the vector space.

The vector space of the phrase feature may have components corresponding not only to words that appear in plural phrases but also to word bigrams or word trigrams that appear in the plural phrases. Furthermore, other parameters such as the kind of part of speech or the attribute of the word may be included in the phrase feature.

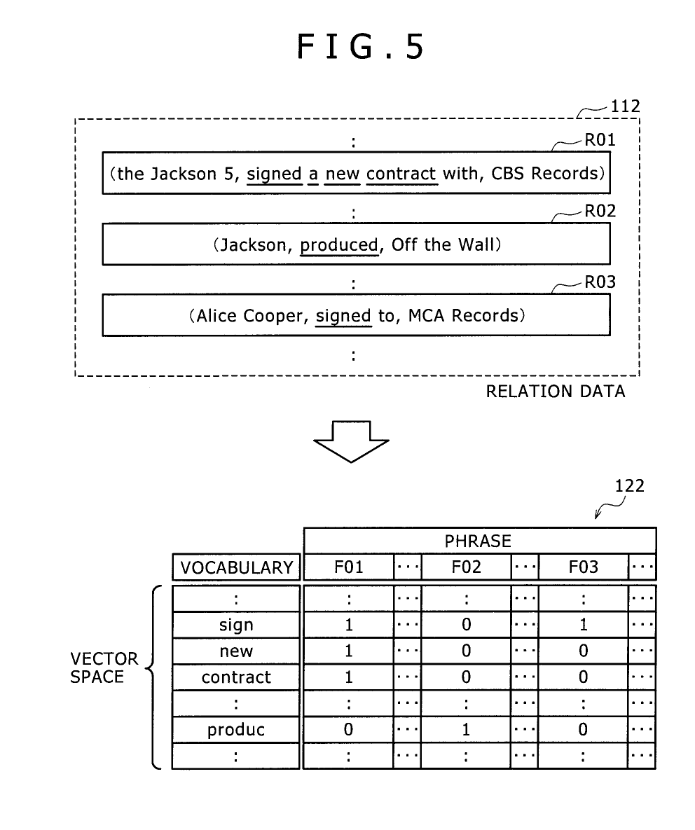

FIG. 5 is an explanatory diagram for explaining the decision of the phrase feature by the phrase feature decider 120.

At the upper stage of FIG. 5, one example of the relation data 112 input from the data acquirer 110 is shown. The relation data 112 includes three relations R01, R02, and R03. The phrase feature decider 120 extracts six words, “signed,” “a,” “new,” “contract,” “produced,” and “signed” from the phrases included in such relation data 112 for example. Next, the data acquirer 110 executes stemming processing (processing for reading stems) about these six words, and then excludes the stop words and so forth to thereby specify unique four words (stems), “sign,” “new,” “contract,” and “produc.” Furthermore, the phrase feature decider 120 forms the vector space of the phrase feature having these “sign,” “new,” “contract,” and “produc” as components.

At the lower stage of FIG. 5, three examples of the phrase feature in the vector space having “sign,” “new,” “contract,” and “produc” as components are shown. A phrase F01 corresponds to the relation R01, and the phrase feature of the phrase F01 is ( . . . , “sign,” “new,” “contract,” . . . , “produc,” . . . )=( . . . , 1, 1, 1, . . . , 0, . . . ). A phrase F02 corresponds to the relation R02, and the phrase feature of the phrase F02 is ( . . . , “sign,” “new,” “contract,” . . . , “produc,” . . . )=( . . . 0, 0, 0, . . . 1, . . . ). A phrase F03 corresponds to the relation R03, and the phrase feature of the phrase F03 is ( . . . , “sign,” “new,” “contract,” . . . , “produc,” . . . )=( . . . , 1, 0, 0, . . . , 0, . . . ). In practice, the phrase feature is obtained as a super-sparse vector in which a much larger number of components exist and a value other than zero is set for only a very-small part of the components. The matrix made by arranging these phrase features on the respective columns (or respective rows) forms a phrase feature matrix 122.

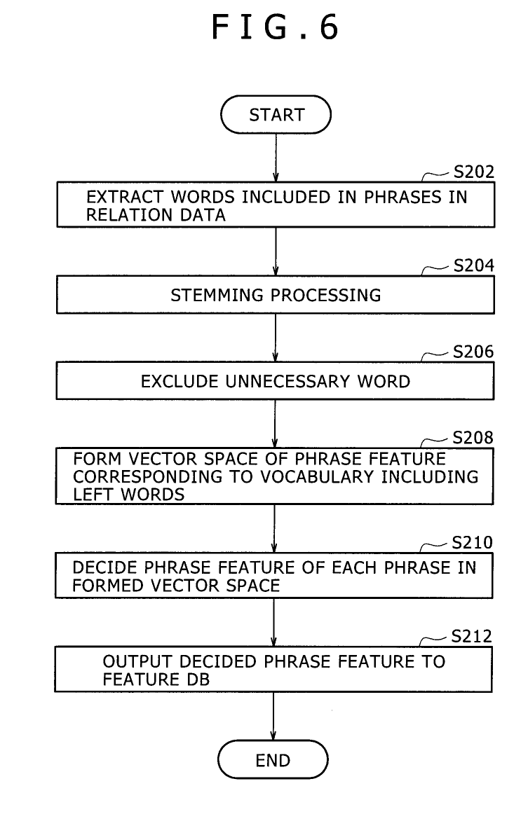

FIG. 6 is a flowchart showing one example of the flow of the phrase feature decision processing by the phrase feature decider 120 according to the present embodiment.

Referring to FIG. 6, first, the phrase feature decider 120 extracts the words included in the phrases in the relation data 112 input from the data acquirer 110 (step S202). Next, the phrase feature decider 120 executes stemming processing for the extracted words to remove the differences in the words due to word inflection (step S204). Next, the phrase feature decider 120 excludes unnecessary words such as the stop words and words having a low TF/IDF score from the words resulting from the stemming processing (step S206). Subsequently, the phrase feature decider 120 forms the vector space of the phrase feature corresponding to the vocabulary including the left words (step S208).

Next, in the formed vector space, the phrase feature decider 120 decides the phrase feature of each phrase depending on the presence or absence of the appearance of the words in the phrase for example (step S210). Subsequently, the phrase feature decider 120 outputs the decided phrase feature of each phrase to the feature DB 140 (step S212).

### [2-4. Collection Feature Decider]

The collection feature decider 130 decides the collection feature representing the characteristic of the sentence collection 104 input from the data acquirer 110. In the present embodiment, the collection feature is a matrix having components each corresponding to a respective one of the combinations of the words that appear in the sentence collection 104. At least part of the above-described vector space of the phrase feature overlaps with part of the vector space of row vectors or columns vectors configuring the collection feature. The collection feature decider 130 may decide the collection feature depending on the number of times of co-occurrence in the sentence collection 104 about each combination of the words for example. In this case, the collection feature is a co-occurrence matrix representing the number of times of co-occurrence of each of the word combinations. Alternatively, the collection feature decider 130 may decide the collection feature depending on a synonymous relationship between the words for example. Further alternatively, the collection feature decider 130 may decide the collection feature reflecting both of the number of times of co-occurrence of each of the word combinations and the numerical value dependent on the synonymous relationship.

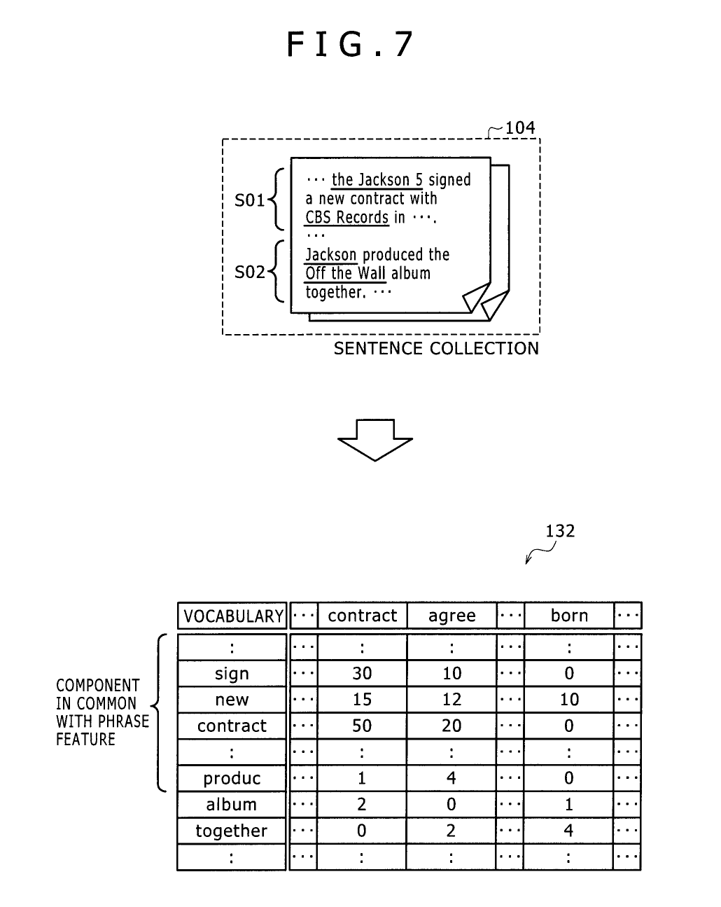

FIG. 7 is an explanatory diagram for explaining the decision of the collection feature by the collection feature decider 130.

At the upper stage of FIG. 7, one example of the sentence collection 104 input from the data acquirer 110 is shown. The sentence collection 104 includes two sentences S01 and S02 and plural other sentences. The collection feature decider 130 extracts the words included in the plural sentences in such a sentence collection 104 for example. Next, the collection feature decider 130 executes stemming processing for the extracted words, and then excludes the stop words and so forth to thereby decide the vocabulary with which the feature space of the collection feature should be formed. In the vocabulary decided in this example, words that appear in the part other than the phrases, such as “album” and “together,” are also included in addition to the words that appear in the phrases, such as “sign,” “new,” “contract,” and “produc,” which serve as the components of the vector space of the phrase feature.

At the lower stage of FIG. 7, a collection feature 132 is shown as a co-occurrence matrix to which the vocabulary of the words that appear in the sentence collection 104 is allocated as components of both of rows and columns. For example, in the collection feature 132, the value of the component corresponding to the combination of “sign” and “contract” is “30.” This value shows that the number of times of the appearance of the combination of “sign” and “contract” in one sentence in the sentence collection 104 (the number of sentences including this combination) is 30. Similarly, the value of the component corresponding to the combination of “sign” and “agree” is “10.” The value of the component corresponding to the combination of “sign” and “born” is “0.” These values show that the numbers of times of the co-occurrence of these word combinations in the sentence collection 104 are 10 and 0, respectively.

For example in the case of deciding the collection feature depending on a synonymous relationship between words, the collection feature decider 130 may decide the collection feature in such a manner as to set “1” as the component corresponding to the combination of words in a synonymous relationship (including equivalence relationship) in a synonym dictionary prepared in advance, and set “0” as the other components. Alternatively, the collection feature decider 130 may perform weighted addition of the numbers of times of co-occurrence about the respective word combinations and the above-described value given depending on the synonym dictionary by using a predetermined factor.

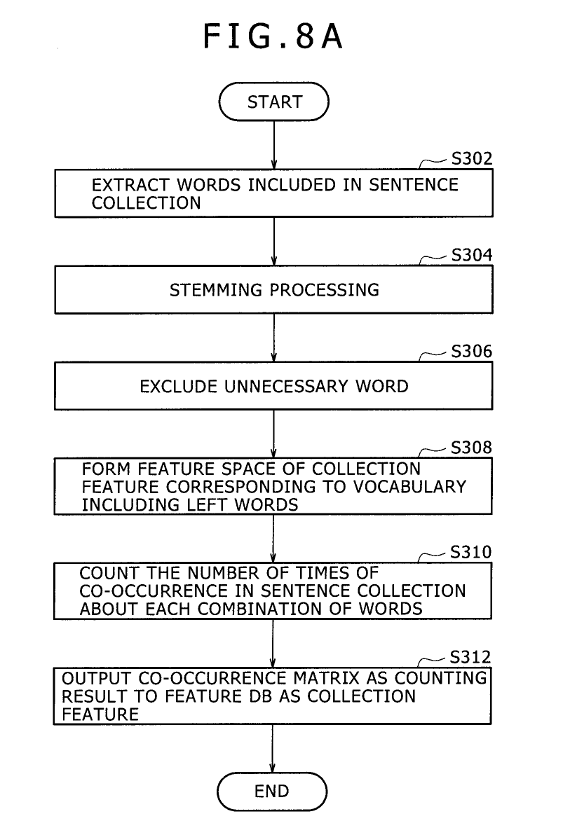

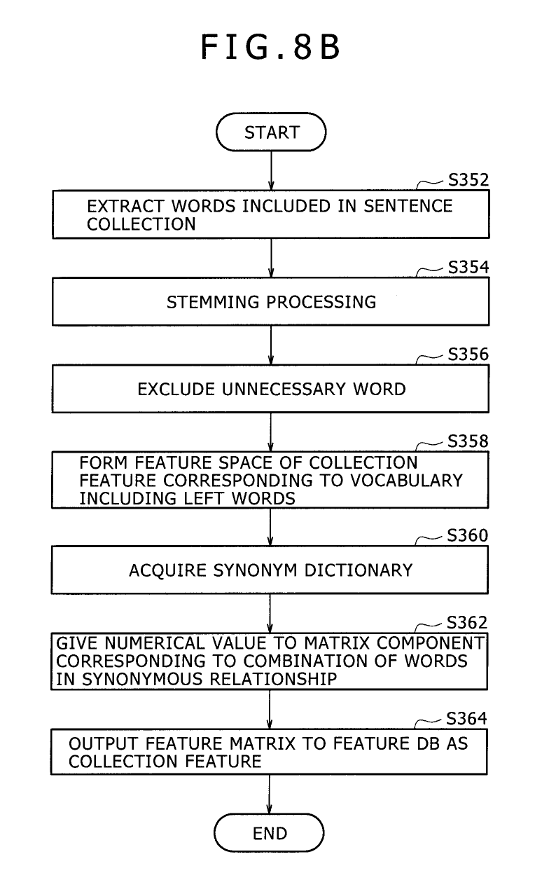

FIG. 8A is a flowchart showing a first example of the flow of the collection feature decision processing by the collection feature decider 130 according to the present embodiment.

Referring to FIG. 8A, first, the collection feature decider 130 extracts the words included in the sentence collection 104 input from the data acquirer 110 (step S302). Next, the collection feature decider 130 executes stemming processing for the extracted words to remove the differences in the words due to word inflection (step S304). Next, the collection feature decider 130 excludes unnecessary words such as the stop words and words having a low TF/IDF score from the words resulting from the stemming processing (step S306). Subsequently, the collection feature decider 130 forms the feature space (matrix space) of the collection feature corresponding to the vocabulary including the left words (step S308).

Next, the collection feature decider 130 counts the number of times of co-occurrence in the sentence collection 104 about each of the word combinations corresponding to the respective components of the formed feature space (step S310). Subsequently, the collection feature decider 130 outputs a co-occurrence matrix as the counting result to the feature DB 140 as the collection feature (step S312).

FIG. 8B is a flowchart showing a second example of the flow of the collection feature decision processing by the collection feature decider 130 according to the present embodiment.

Referring to FIG. 8B, first, the collection feature decider 130 extracts the words included in the sentence collection 104 input from the data acquirer 110 (step S352). Next, the collection feature decider 130 executes stemming processing for the extracted words to remove the differences in the words due to word inflection (step S354). Next, the collection feature decider 130 excludes unnecessary words such as the stop words and words having a low TF/IDF score from the words resulting from the stemming processing (step S356). Subsequently, the collection feature decider 130 forms the feature space (matrix space) of the collection feature corresponding to the vocabulary including the left words (step S358). The processing executed thus far is the same as that of the step S302 to the step S308 in FIG. 8A.

Next, the collection feature decider 130 acquires a synonym dictionary (step S360). Next, the collection feature decider 130 gives a numerical value to the matrix components corresponding to the combinations of words in a synonymous relationship in the acquired synonym dictionary (step S362). Subsequently, the collection feature decider 130 outputs a feature matrix obtained by giving the numerical value to the respective components to the feature DB 140 as the collection feature (step S364).

### [2-5. Feature DB]

The feature DB 140 stores the phrase features decided by the phrase feature decider 120 and the collection feature decided by the collection feature decider 130 by using a storage medium. Furthermore, the feature DB 140 outputs the stored phrase features and collection feature to the compressor 150 in response to a request from the compressor 150.

### [2-6. Compressor]

The compressor 150 generates compressed phrase features that have a dimension lower than that of the above-described phrase feature and represent the characteristics of the respective phrases acquired by the data acquirer 110, by using the phrase features and the collection feature input from the feature DB 140.

As described with use of FIG. 5, the phrase feature decided by the phrase feature decider 120 is super-sparse vector quantity. Therefore, even when a vector compression technique based on a publicly-known probabilistic technique is simply applied to the phrase feature, the significance of the data tends to be lost due to the compression. So, the compressor 150 according to the present embodiment treats the above-described collection feature as observed data in addition to the phrase feature, to thereby compress the phrase feature by using a probabilistic technique with compensation for the little information of the feature. This allows effective training of the compressed data by not only the independent statistical characteristics of phrases but also the statistical characteristic of the sentence collection to which the phrases belong.

In the probabilistic model utilized by the compressor 150, the phrase features about plural phrases and the collection feature are treated as observed data and latent variates contribute to the occurrence of this observed data. Furthermore, in the probabilistic model utilized by the compressor 150, the latent variates that contribute to the occurrence of the collection feature and the latent variates that contribute to the occurrence of the phrase features about plural phrases are variates that are in common with each other at least partially. Such a probabilistic model is represented by e.g. the following equation (1).

$$\begin{matrix} [ Expression 1 ] & \\ p ( X , F \vert U , V , {α}_{X} , {α}_{F} ) = {\prod }_{i = 1}^{N} {\prod }_{j = 1}^{M} [ p ( {x}_{ij} \vert {U}_{i} , {V}_{j} , {α}_{X} ) ] \cdot {\prod }_{j = 1}^{L} {\prod }_{k = 1}^{L} [ p ( {f}_{jk} \vert {V}_{j} , {V}_{k} , {α}_{F} ) ] & ( 1 )\end{matrix}$$

In equation (1), X(xᵢⱼ) represents a phrase feature matrix. F(fⱼₖ) represents a collection feature (matrix). Uᵢ represents the latent vector corresponding to the i-th phrase. Vⱼ (or Vₖ) represents the latent vector corresponding to the j-th (or k-th) word. αₓ is equivalent to the accuracy of the phrase feature and gives the dispersion of normal distribution in the following equation (2). α_{F} is equivalent to the accuracy of the collection feature and gives the dispersion of normal distribution in the following equation (3). N represents the total number of acquired phrases. M represents the dimension of the vector space of the phrase feature. L represents the order of the collection feature. Two random variables in the right side of equation (1) are defined as shown by the following equations. G(x|μ, α) is normal distribution in which the average is μ and the accuracy is α.

[Expression 2]

p(xᵢⱼ|Uᵢ,Vⱼ,αₓ)=G(xᵢⱼ|Uᵢ^{T}Vⱼ,αₓ) (2)

p(fⱼₖ|Vⱼ,Vₖ,α_{F})=G(fⱼₖ|Vⱼ^{T}Vₖ,α_{F}) (3)

Based on such a probabilistic model, the compressor 150 sets conjugate prior distribution and then estimates N latent vectors Uᵢ and L latent vectors Vⱼ, which are latent variates, in accordance with maximum likelihood estimation such as maximum a posteriori estimation or Bayes estimation. Furthermore, the compressor 150 outputs the latent vectors Uᵢ (i=1 to N) about the respective phrases obtained as the estimation result to the compressed feature DB 160 as the compressed phrase features of the respective phrases.

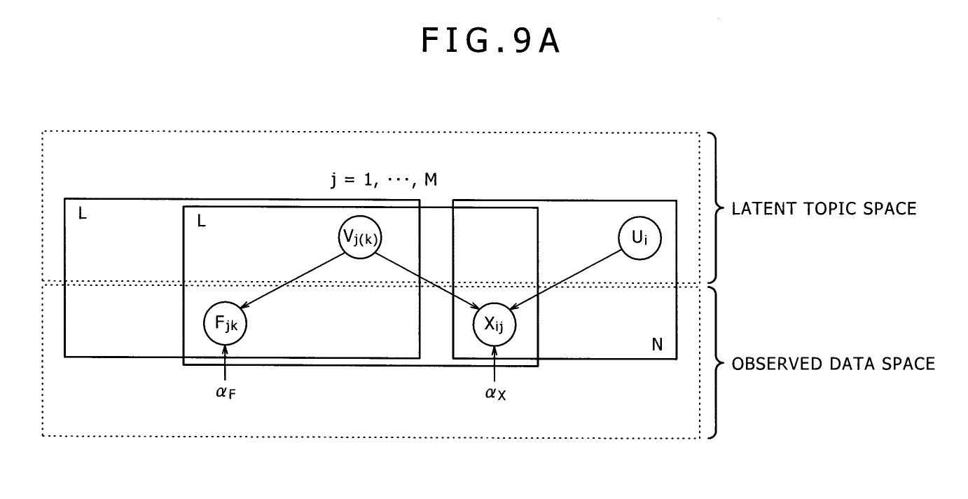

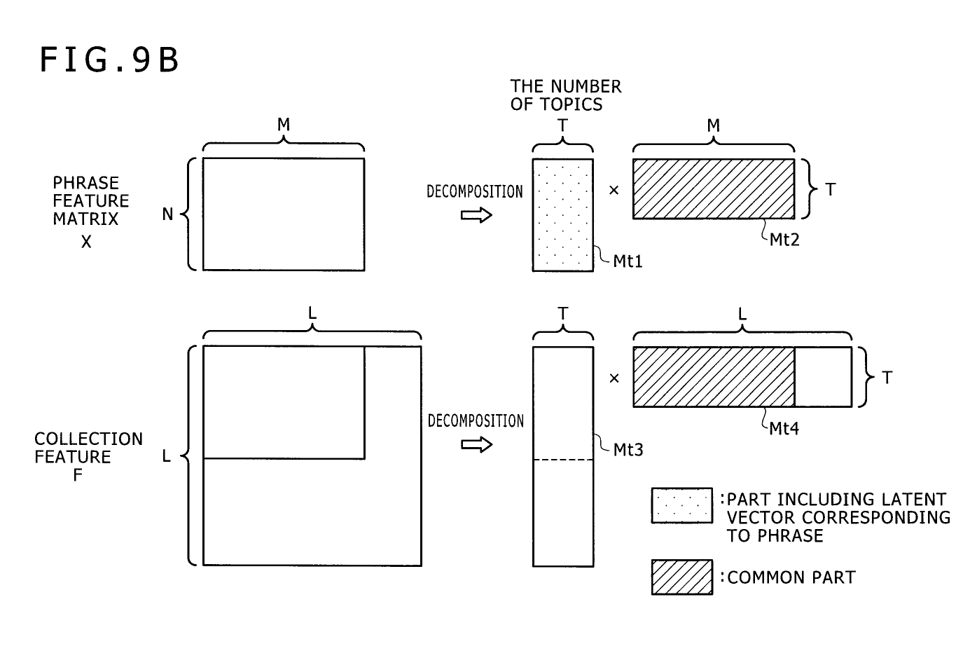

FIG. 9A and FIG. 9B are explanatory diagrams for conceptually explaining, from a different aspect, the idea of the present embodiment about the compression of the phrase feature.

Referring to FIG. 9A, a latent topic space as one example of the data space of the latent variate is shown at the upper part, and the observed data space is shown at the lower part. The latent vector U, belongs to the latent topic space and contributes to the occurrence of the i-th phrase observed in the sentence collection. This means that the semantic aspect possessed by the phrase probabilistically affects the appearance of the phrase as language. On the other hand, the latent vector Vⱼ (Vₖ) as well as the latent vector U, contributes to the occurrence of the j-th word included in the i-th phrase. This means that e.g. the semantic aspect of context in the sentence collection (or e.g. linguistic tendency of the document) probabilistically affects the appearance of the individual word. At this time, the latent vector Vⱼ (Vₖ) contributes not only to the occurrence of the j-th word included in the i-th phrase but also to the occurrence of a word in another part of the sentence collection other than the phrase to which attention is paid. Therefore, by observing the collection feature fⱼₖ in addition to the phrase feature xᵢⱼ of the i-th phrase, the latent vector Uⱼ and the latent vector Vⱼ (Vₖ) can be favorably estimated. The dimension of the latent vectors Uᵢ and Vⱼ is equal to the number of topics in the latent topic space. By setting the number of topics to a number smaller than the dimension of the phrase feature, the latent vector Uᵢ having a dimension lower than that of the phrase feature can be achieved as the compressed phrase feature. The number of topics in the latent topic space can be set to a proper number (e.g. 20) dependent on e.g. the requirements for subsequent-stage processing or restrictions on the resource.

At the upper stage of FIG. 9B, a phrase feature matrix X with N rows and M columns is shown. At the lower stage of FIG. 9B, a collection feature F with L rows and L columns is shown. It should be noted that, in the phrase feature matrix X and the collection feature F in FIG. 9B, the rows and the columns are inverted from each other with respect to the phrase feature matrix 122 and the collection feature 132 shown in FIG. 5 and FIG. 7, respectively.

For example, if the number of topics in the latent topic space shown in FIG. 9A is defined as T, the phrase feature matrix X with N rows and M columns shown in FIG. 9B can be decomposed into the product of a lower-order matrix Mt1 with N rows and T columns and a lower-order matrix Mt2 with T rows and M columns, having lower orders. Of these matrices, the lower-order matrix Mt1 is a matrix made by arranging the T-dimensional latent vectors Uᵢ on the respective rows. Similarly, the collection feature F with L rows and L columns can be decomposed into the product of a lower-order matrix Mt3 with L rows and T columns and a lower-order matrix Mt4 with T rows and L columns. Of these matrices, the lower-order matrix Mt3 is a matrix made by arranging the T-dimensional latent vectors Vⱼ on the respective rows. Under the assumption that the latent variates in the hatched part of the lower-order matrix Mt2 and the latent variates in the hatched part of the lower-order matrix Mt4 have the same values, the compressor 150 estimates the likelihood lower-order matrices Mt1, Mt2, Mt3, and Mt4 that approximately derive the phrase feature matrix X and the collection feature F. This allows the compressor 150 to achieve the more significant lower-order matrix Mt1 (i.e. latent vectors Uᵢ) compared with the case of estimating the lower-order matrices Mt1 and Mt2 from only the phrase feature matrix X.

In the example of FIG. 9B, the order L of the collection feature is higher than the dimension M of the vector space of the phrase feature. Typically, by setting L>M, the significance of the compression of the phrase feature can be enhanced based on not only the words that appear in the phrases but also the tendency of the words that do not appear in the phrases but appear in the sentence collection to which the phrases belong. However, the advantageous effect of the present embodiment can be achieved even if a relationship of L=M or L<M is set for example. The reason for this is that normally the collection feature with L rows and L columns is denser than the phrase feature matrix with N rows and M columns (or is not “super-sparse”) and thus compensation for the little information of the phrase feature is still achieved by the collection feature.

### [2-7. Compressed Feature DB]

The compressed feature DB 160 stores the compressed phrase features generated by the compressor 150 by using a storage medium. Furthermore, the compressed feature DB 160 outputs the stored compressed phrase features to the clustering part 170 in response to a request from the clustering part 170. Moreover, the compressed feature DB 160 stores the result of clustering by the clustering part 170 in association with the compressed phrase features.

### [2-8. Clustering Part]

The clustering part 170 performs clustering of plural compressed phrase features generated by the compressor 150 depending on the similarity between the features. The clustering processing by the clustering part 170 may be executed in accordance with a publicly-known clustering algorithm such as K-means. The clustering part 170 gives each of one or more clusters generated as the result of the clustering a label corresponding to the phrase as the representative of the cluster. The clusters to which the label is given may be not all of the clusters generated in accordance with the clustering algorithm but partial clusters satisfying e.g. the following selection condition.
Selection condition: the number of phrases in the cluster (overlapping phrases are also counted separately) is within the top N_{f} among all of the clusters and the similarity of the compressed phrase feature about all of the pairs of the phrases in the cluster is equal to or higher than a predetermined threshold.

As the similarity in the above-described selection condition, e.g. the cosine similarity or the inner product between compressed phrase features can be used.

The phrase as the representative of the selected cluster may be e.g. the most included phrase in the cluster among the unique phrases in the cluster. For example, the clustering part 170 may calculate the sum of the compressed phrase feature for each of the phrases having the same string and may give the string of the phrase having the largest sum as the label of the cluster.

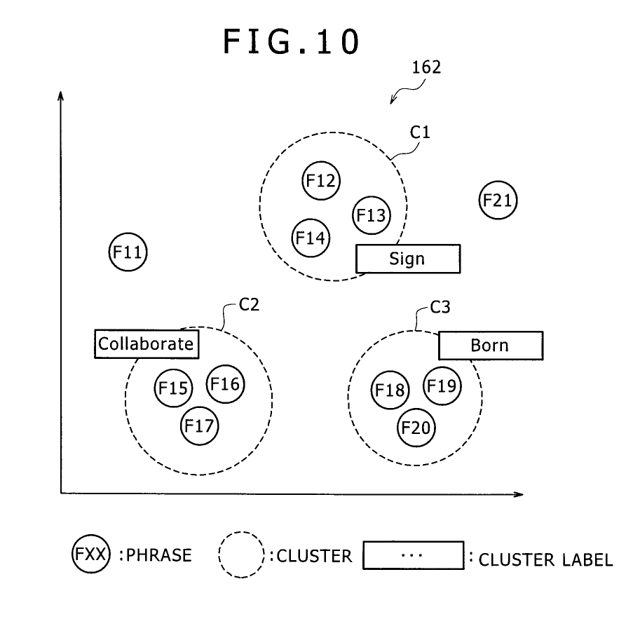

FIG. 10 is an explanatory diagram for explaining one example of the result of clustering of phrases by the clustering part 170.

Referring to FIG. 10, in a compressed phrase feature space 162, 11 phrases F11 to F21 are each shown at the position corresponding to the compressed phrase feature. Among them, the phrases F12 to F14 are classified in a cluster C1. The phrases F15 to F17 are classified in a cluster C2. The phrases F18 to F20 are classified in a cluster C3. A string of “Sign” is given to the cluster C1 as its label. A string of “Collaborate” is given to the cluster C2 as its label. A string of “Born” is given to the cluster C3 as its label. The labels of these clusters are given corresponding to the string of the phrase as the representative of the cluster. The clustering part 170 stores such a clustering result in the compressed feature DB 160 in association with the compressed phrase features.

Instead of giving the label of the cluster corresponding to the phrase as the representative of the cluster, if a phrase whose cluster, to which this phrase should belong, is known (hereinafter, this phrase will be referred to as the teacher phrase) is given in advance, the teacher phrase or a string associated with the teacher phrase may be given as the label of the cluster.

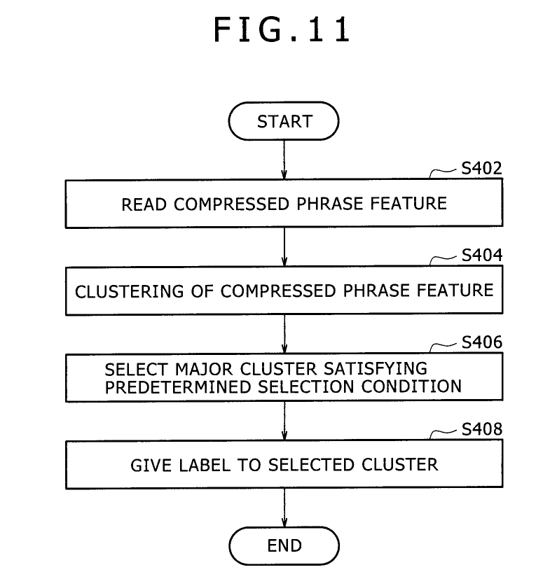

FIG. 11 is a flowchart showing one example of the flow of the clustering processing by the clustering part 170 according to the present embodiment.

Referring to FIG. 11, first, the clustering part 170 reads, from the compressed feature DB 160, the compressed phrase features about plural phrases included in the sentence collection 104 (step S402). Next, the clustering part 170 performs clustering of the compressed phrase features in accordance with a publicly-known clustering algorithm (step S404). Next, the clustering part 170 determines whether or not the cluster satisfies the predetermined selection condition for each of the clusters and selects major clusters satisfying the predetermined selection condition (step S406). Next, the clustering part 170 gives each of the selected clusters a label corresponding to the string of the phrase as the representative of the cluster (step S408).

### [2-9. Summarizer]

The summarizer 180 pays attention to a specific word included in the sentence collection 104 and creates summary information about the attention word by using the result of the clustering by the clustering part 170 about phrases relating to the attention word. Specifically, the summarizer 180 extracts plural relations relating to the attention word from the relation data 112 for example. Furthermore, if the phrase of the first relation extracted and the phrase of the second relation are both classified in one cluster, the summarizer 180 adds the other word in the first relation and the other word in the second relation to the contents of the summary about the label given to this one cluster.

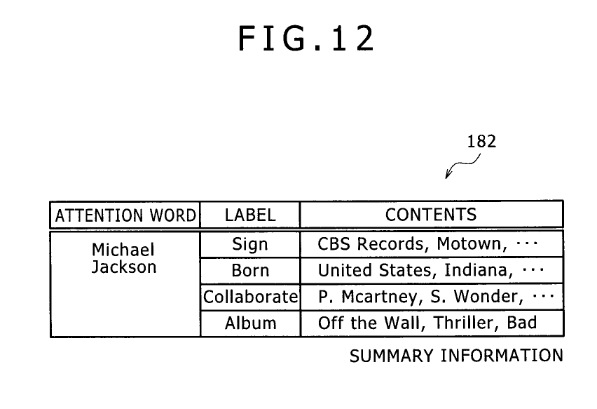

FIG. 12 shows summary information 182 as one example created by the summarizer 180. The attention word in the summary information 182 is “Michael Jackson.” The summary information 182 includes four labels, “Sign,” “Born,” “Collaborate,” and “Album.” In the summary information 182, the contents about the label “Sign” include “CBS Records” and “Motown.” An entry of such summary information 182 is possibly created in the following case for example. Specifically, the phrase about the word pair of “Michael Jackson,” which is the attention word, and “CBS Records” is “signed to” and the phrase about the word pair of “Michael Jackson” and “Motown” is “contracted with.” In addition, these phrases are both classified in the cluster whose label is “Sign.”

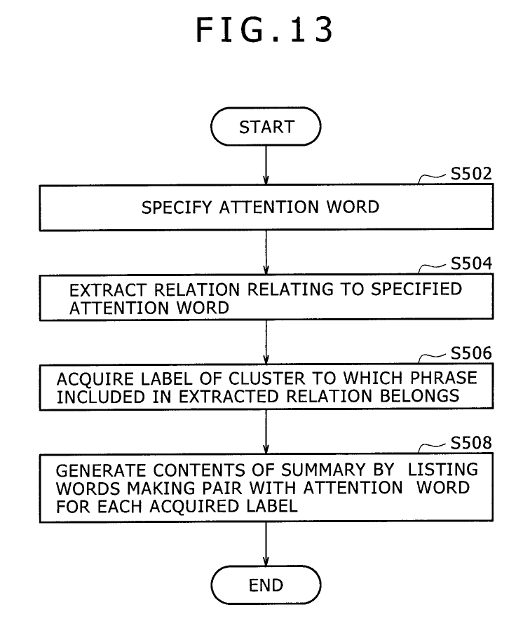

FIG. 13 is a flowchart showing one example of the flow of the summary information creation processing by the summarizer 180 according to the present embodiment.

Referring to FIG. 13, first, the summarizer 180 specifies the attention word (step S502). The attention word may be e.g. a word specified by the user. Instead, for example, the summarizer 180 may automatically specify one or more words such as a proper noun included in the relation data 112 as the attention word. Next, the summarizer 180 extracts relations relating to the specified attention word from the relation data 112 (step S504). The relation relating to the attention word refers to e.g. the relation in which one of the words of the word pair is the attention word. Next, the summarizer 180 acquires the labels of the clusters to which the phrases included in the extracted relations belong from the clustering result (step S506). Subsequently, the summarizer 180 generates the contents of the summary by listing the words making a pair with the attention word for each of the acquired labels (step S508). The summarizer 180 outputs the summary information 182 created in this manner to the summary DB 190.

### [2-10. Summary DB]

The summary DB 190 stores the summary information 182 created by the summarizer 180 by using a storage medium. The summary information 182 stored by the summary DB 190 can be utilized by applications inside or outside the information processing device 100 having various objects such as information retrieval, advertisement, or recommendation.

### 3. Flow of Information Processing

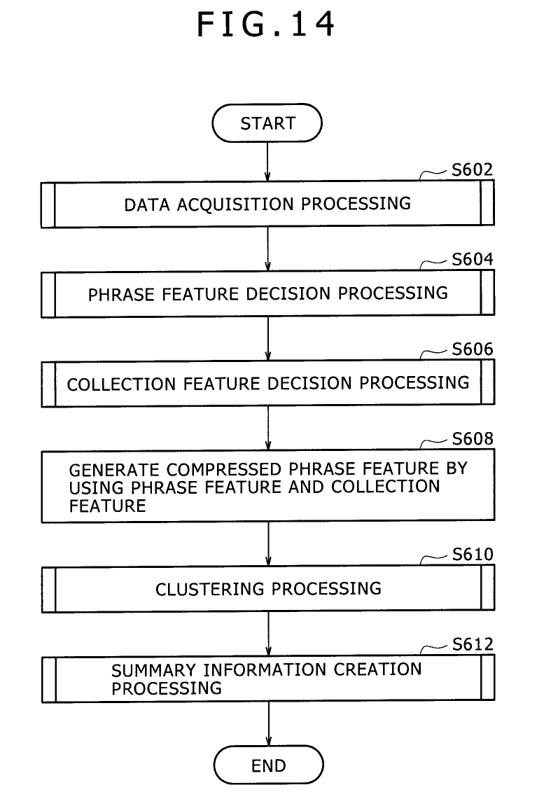

FIG. 14 is a flowchart showing one example of the overall flow of the information processing by the information processing device 100 according to the present embodiment. Referring to FIG. 14, first, the data acquisition processing described with FIG. 4 is executed by the data acquirer 110 in the information processing device 100 (step S602). Next, the phrase feature decision processing described with FIG. 6 is executed by the phrase feature decider 120 (step S604). Next, the collection feature decision processing described with FIG. 8A or FIG. 8B is executed by the collection feature decider 130 (step S606). Next, the compressor 150 generates the compressed phrase features by using the phrase features and the collection feature in accordance with the technique described with FIG. 9A and FIG. 9B (step S608). Next, the clustering processing described with FIG. 11 is executed by the clustering part 170 (step S610). Subsequently, the summary information creation processing described with FIG. 13 is executed by the summarizer 180 (step S612).

### 4. Application Examples

The description of the present embodiment relates to the example in which the result of clustering about compressed phrase features is utilized to create summary information. However, the compressed phrase feature generated in accordance with the present embodiment can be applied also to use purposes other than the above-described ones.

For example, in the case of questions collected from customers via a form on the Web, e-mails, etc., the customers tend to use different expressions even when their questions have the same gist. For example, when a television screen involves a drawback, a certain user may say that “noise is noticeable” and another user may say that “TV reception is poor.” In addition, further another user may say that “the image quality involves a problem.” In such a case, by using a clustering result about compressed phrase features favorably obtained in accordance with the present embodiment, the system can automatically recognize that all questions have a similar gist. This makes it possible to guide the customers to proper inquiry services or rapidly provide proper answers to the customers.

Also in speech made by a person, one same or similar meaning is possibly expressed by a variety of language. Therefore, for an agent such as a computer or a robot having a conversation with a person through speech recognition, it is not easy to correctly understand the meanings of a variety of language and return proper replies. However, by using a clustering result about compressed phrase features favorably obtained in accordance with the present embodiment, the agent can understand the meanings of a variety of language delivered by a person more correctly. As one example, the present embodiment can be applied to an agent that properly understands the meaning of a direction input by speech from a person and takes action even when this direction involves difference in the expression. As another example, the present embodiment can be applied also to an agent that expresses one meaning that is the transmission subject by using a variety of phrases when outputting speech to a person.

Furthermore, the clustering result according to the present embodiment can be applied also to e.g. a system to recommend information or contents relating to one of the words of a word pair to the user if the other of the words is the subject of the action of the user (e.g. information browsing or viewing or purchase of contents). For example, in the recommendation, by presenting the label of the corresponding cluster as the reason for the recommendation of information or contents, user's feeling of satisfaction at the recommendation can be enhanced.

### 5. Summary

The information processing device 100 according to one embodiment of the present invention has been described above with use of FIG. 1 to FIG. 14. According to the present embodiment, the compressed phrase feature having a dimension lower than that of the phrase feature is generated by using the collection feature representing the characteristic of the sentence collection as the acquisition source of phrases in addition to the phrase features representing the characteristics of the phrases. This configuration can compress the dimension of the phrase features with maintenance or enhancement of the significance of the features. Thereby, for example, a lower-dimensional phrase feature that allows effective execution of subsequent-stage processing such as clustering is provided even when a large-scale data collection cannot be ensured because of e.g. restrictions on the resource or the property of texts as the subject.

Furthermore, according to the present embodiment, the phrase feature is vector quantity having components each corresponding to a respective one of the words that appear in plural phrases. In addition, the collection feature is a matrix having components each corresponding to a respective one of the combinations of the words that appear in the sentence collection. This configuration allows overlapping of at least part of the vector space of the phrase feature with part of the vector space of row vectors or columns vectors configuring the collection feature. Thereby, the phrase feature can be compressed by using a probabilistic technique with compensation for the little information of the phrase feature by the collection feature.

In addition, the present embodiment provides a probabilistic model in which the phrase features about plural phrases and the collection feature are treated as observed data and latent variates contribute to the occurrence of this observed data. By applying maximum likelihood estimation to such a probabilistic model, the compressed phrase features are trained more favorably and the significance of the compressed phrase features is enhanced.

Moreover, according to the present embodiment, the collection feature is decided depending on the number of times of co-occurrence in the sentence collection about each of the word combinations or a synonymous relationship between words or both of them. Such a collection feature reflects the semantic aspect of context in the sentence collection or directly represents the synonymous relationship between words. This enables training of the compressed phrase features suitable for clustering aimed at recognition of an equivalence or synonymous relationship of phrases.

The series of processing by the information processing device 100, described in the present specification, is typically realized by using software. Programs configuring the software to realize the series of processing are stored in advance in a storage medium provided inside or outside the information processing device 100 for example. When being executed, each program is read into a random access memory (RAM) in the information processing device 100 and executed by a processor such as a central processing unit (CPU).

Although a preferred embodiment of the present invention has been described in detail above with reference to the accompanying drawings, the present invention is not limited to this example. It is apparent that those who have normal knowledge in the technical field to which the present invention belongs can reach various kinds of change examples or modification examples within the category of the technical idea described in the scope of claims, and it should be understood that these examples also belong to the technical range of the present invention naturally.

The present application contains subject matter related to that disclosed in Japanese Priority Patent Application JP 2010-097917 filed in the Japan Patent Office on Apr. 21, 2010, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. An information processing device comprising:
a data acquirer configured to acquire a sentence collection having a plurality of sentences and a plurality of phrases included in the sentence collection;
a phrase feature decider configured to decide phrase features each representing a characteristic of a respective one of the phrases acquired by the data acquirer;
a collection feature decider configured to decide a collection feature representing a characteristic of the sentence collection; and
a compressor configured to generate compressed phrase features by using the phrase features and the collection feature, the compressed phrase features having a dimension lower than a dimension of the phrase features and each representing a characteristic of the respective one of the phrases acquired by the data acquirer.

2. The information processing device according to claim 1, wherein
the phrase feature is vector quantity having components each corresponding to a respective one of words that appear in the plurality of phrases.

3. The information processing device according to claim 2, wherein
the collection feature is a matrix having components each corresponding to a respective one of combinations of words that appear in the sentence collection, and
at least part of a vector space of the phrase feature overlaps with part of a vector space of row vectors or column vectors configuring the collection feature.

4. The information processing device according to claim 3, wherein
the compressor calculates a latent variate by maximum likelihood estimation in a probabilistic model in which the phrase features about the plurality of phrases and the collection feature are treated as observed data and the latent variate contributes to occurrence of the observed data, and
the compressed phrase feature is included in the latent variate.

5. The information processing device according to claim 4, wherein
a latent variate that contributes to occurrence of the collection feature and a latent variate that contributes to occurrence of the phrase feature are latent variates that are in common with each other at least partially in the probabilistic model.

6. The information processing device according to claim 3, wherein
the compressor calculates a first lower-order matrix having an order lower than an order of the collection feature by matrix decomposition of the collection feature, and calculates a second lower-order matrix having an order lower than an order of a phrase feature matrix including the phrase features about the plurality of phrases by matrix decomposition of the phrase feature matrix,
the second lower-order matrix is a matrix that approximately derives the phrase feature matrix by a product with a matrix having part in common with the first lower-order matrix, and
the compressed phrase feature is included in the second lower-order matrix.

7. The information processing device according to claim 3, wherein
the collection feature decider decides the collection feature depending on the number of times of co-occurrence in the sentence collection about each of the combinations of the words.

8. The information processing device according to claim 3, wherein
the collection feature decider decides the collection feature depending on a synonymous relationship between words.

9. The information processing device according to claim 1, further comprising
a clustering part configured to perform clustering of a plurality of compressed phrase features generated by the compressor depending on similarity between features.

10. The information processing device according to claim 9, wherein
the clustering part gives each of at least one clusters generated as a result of clustering a label corresponding to a phrase as a representative of the cluster.

11. The information processing device according to claim 1, wherein
the data acquirer extracts pairs of words that are both included in one sentence in the sentence collection and acquires the plurality of phrases each representing a relation between the words about a respective one of the extracted pairs.

12. The information processing device according to claim 11, further comprising:
a clustering part configured to perform clustering of a plurality of compressed phrase features generated by the compressor depending on similarity between features; and
a summarizer configured to pay attention to a specific word included in the sentence collection and create summary information about an attention word by using a result of clustering by the clustering part about phrases relating to the attention word.

13. An information processing method carried out by using processing means in an information processing device, the information processing method comprising the steps of:
acquiring a sentence collection having a plurality of sentences and a plurality of phrases included in the sentence collection;
deciding phrase features each representing a characteristic of a respective one of the acquired phrases;
deciding a collection feature representing a characteristic of the acquired sentence collection; and
generating compressed phrase features by using the phrase features and the collection feature, the compressed phrase features having a dimension lower than a dimension of the phrase features and each representing a characteristic of a respective one of phrases among the plurality of phrases.

14. A program for causing a computer that controls an information processing device to function as processing means comprising:
a data acquirer configured to acquire a sentence collection having a plurality of sentences and a plurality of phrases included in the sentence collection;
a phrase feature decider configured to decide phrase features each representing a characteristic of a respective one of the phrases acquired by the data acquirer;
a collection feature decider configured to decide a collection feature representing a characteristic of the sentence collection; and
a compressor configured to generate compressed phrase features by using the phrase features and the collection feature, the compressed phrase features having a dimension lower than a dimension of the phrase features and each representing a characteristic of the respective one of the phrases acquired by the data acquirer.

15. An information processing device comprising:
data acquisition means for acquiring a sentence collection having a plurality of sentences and a plurality of phrases included in the sentence collection;
phrase feature decision means for deciding phrase features each representing a characteristic of a respective one of the phrases acquired by the data acquisition means;
collection feature decision means for deciding a collection feature representing a characteristic of the sentence collection; and
compression means for generating compressed phrase features by using the phrase features and the collection feature, the compressed phrase features having a dimension lower than a dimension of the phrase features and each representing a characteristic of the respective one of the phrases acquired by the data acquisition means.
